(19) United States
(12) Patent Application Publication
(10) Pub. No.: US 2015/0149340 A1
(43) Pub. Date: May 28, 2015

(54) Tandem Options Contracts Providing Fixed Binary Payout

(71) Applicant: Chicago Mercantile Exchange, Inc., Chicago, IL (US)

(72) Inventors: David Bixby, Arlington Heights, IL (US); Edward Gogol, Skokie, IL (US); John Labuszewski, Westmont, IL (US); Charles Piszczor, West Dundee, IL (US); John Nyhoff, Darien, IL (US); Heidi Centola, Chicago, IL (US)

(73) Assignee: Chicago Mercantile Exchange, Inc., Chicago, IL (US)

(21) Appl. No.: 14/090,406

(22) Filed: Nov. 26, 2013

(51) Int. Cl. G06Q 40/04

(52) U.S. Cl. CPC G06Q 40/04
USPC 705/37

(57) ABSTRACT

Systems and methods are described where two call options (or two put options) on futures may be bundled, traded, and processed in tandem accordingly. The two options may form a tandem option that may be constructed with strike/exercise prices that are scaled to be one minimum price increment or tick apart in the underlying futures market. The tandem option product provides a payout at expiration that is binary in nature—it will either be zero or a fixed monetary amount.

### BACKGROUND

In the financial industry, traders sometimes desire to trade multiple financial instruments in combination using what is often called a spread order. A spread is an order for two or more contracts. The price of a spread may entail the price difference between two contracts, or it may represent the sum of the prices of the spread's component legs. This results in the trader holding a long and a short position in two or more related futures or options on futures contracts, with the objective of profiting from a change in the price relationship. Each component of the combination is called a leg. Traders can define the combination (e.g., an exchange-defined combination) and submit orders for each leg or in some cases can submit a single order for multiple financial instruments to avoid leg risk. Such orders may be called a strategy order, a spread order, or a variety of other names. The counterparty orders that are matched against the aforementioned combination orders may be individual, “outright” orders or may be part of other combination orders. In the case of spread orders, the matching system may imply the counter party order by using multiple orders to create the counter party order. Examples of spreads include crack, crush, straddle, strangle, butterfly, calendar, bundle and pack spreads.

A butterfly spread using futures contracts is an order for two inter-delivery spreads in opposite directions with the center delivery month common to both spreads. A calendar spread, also called an intra-commodity spread, for futures is an order for the simultaneous purchase and sale of the same futures contract in different contract months. (i.e., buying a September CME S&P 500® futures contract and selling a December CME S&P 500 futures contract). A crush spread is an order, usually in the soybean futures market, for the simultaneous purchase of soybean futures and the sale of soybean meal and soybean oil futures to establish a processing margin. A crack spread is an order for a specific spread trade involving simultaneously buying and selling contracts in crude oil and one or more derivative products, typically gasoline and heating oil. Oil refineries may trade a crack spread to hedge the price risk of their operations, while speculators attempt to profit from a change in the oil/gasoline price differential.

A straddle is an order for the purchase or sale of an equal number of puts and calls, with the same strike price and expiration dates. A long straddle is a straddle in which a long position is taken in both a put and a call option. A short straddle is a straddle in which a short position is taken in both a put and a call option. A strangle is an order for the purchase of a put and a call, in which the options have the same expiration and the put strike is lower than the call strike, called a long strangle. Also the sale of a put and a call, in which the options have the same expiration and the put strike is lower than the call strike, called a short strangle. A pack is an order for the simultaneous purchase or sale of an equally weighted, consecutive series of four futures contracts, quoted on an average net change basis from the previous day's settlement price. Packs provide a readily available, widely accepted method for executing multiple futures contracts with a single transaction. A bundle is an order for the simultaneous sale or purchase of one each of a series of consecutive futures contracts. Bundles provide a readily available, widely accepted method for executing multiple futures contracts with a single transaction.

In addition, event contracts are known in the financial industry. For example, current event contracts contemplate the direct payment of a fixed monetary amount upon realization of the triggering event. Such event contracts may be created for weather events and may be associated with values such as wind speed or rain fall.

While spread orders and event contracts are known in the financial industry, there exist drawbacks to these financial instruments and systems involving these financial instruments that have not yet been identified and resolved.

### BRIEF SUMMARY

The present disclosure overcomes limitations of the prior art by describing methods and systems that provide for, among other things, a tandem option providing a fixed, binary payout. In one example, a method is disclosed comprising: receiving an order for a tandem option, wherein the order comprises numerous parameters; generating the tandem option, which comprises a first options contract with a long position on a specified underlying financial instrument with a first strike price and a specified expiration date, and a second options contract with the short position on the specified underlying financial instrument with a second strike price and the same specified expiration date; and/or storing the tandem option in computer memory; and upon occurrence of the specified expiration date, causing a binary payout. The binary payout may be one of nothing or a predetermined amount (i.e., the preset minimum price increment scaled by a preset multiplier). In addition, one of the two strike prices may be set equal to the specified strike price, and the other strike price may be set equal to the specified strike price minus a preset minimum price increment of the specified underlying financial instrument. Moreover, in some examples, the specified expiration date is a fixed date that coincides with a final settlement date of the specified underlying financial instrument.

Furthermore, one or more of the parameters of the order for the tandem option may include: the specified underlying financial instrument, the specified expiration date, the specified strike price, and/or the specified position. Once created using these parameters, the tandem option may be stored in non-transitory computer-readable memory, such as at an exchange and/or at a clearinghouse. In addition, one or more of the parameter values may be used in calculating the amount to credit an accountholder of the tandem option with a binary payout.

Of course, the methods and systems of the above-referenced examples may also include other additional elements, steps, computer-executable instructions, or computer-readable data structures. In this regard, other examples are disclosed and/or claimed herein as well. In other examples, the systems and methods may be partially or wholly implemented on a one or more computer-readable media, for example, by storing computer-executable instructions or modules, or by utilizing computer-readable data structures. These instructions may be executed by at least one processor of a computing device to perform one or more steps of the methods disclosed herein. For example, the computer system may comprise one or more computer processors and one or more tangible, non-transitory computer memory storing computer-executable instructions, which when executed by the processor, causes the computer system to perform one or more of the steps described herein. The details of these and other examples are set forth in the accompanying drawings and the description herein. Other features and advantages of the disclosed method, systems, and apparatus will be apparent from the description, drawings, and appendices.

### BRIEF DESCRIPTION OF DRAWINGS

Embodiments of the disclosure may take physical form in certain parts and steps, examples of which will be described in detail in the following description and illustrated in the accompanying drawings that form a part hereof, wherein:

FIG. 1 depicts an illustrative computer network system that may be used to implement various aspects of the systems disclosed herein;

FIG. 2 illustrates a graphical depiction of an illustrative tandem option that may be used to with various aspects of the systems disclosed herein; and

FIG. 3A and FIG. 3B show illustrative flowcharts of various steps that may be performed in accordance with various aspects of the systems disclosed herein.

### DETAILED DESCRIPTION

This disclosure generally relates to systems and methods that are utilized in connection with the electronic trading of financial instruments, such as a tandem option. Moreover, this disclosure describes examples of systems and methods that may be deployed as a means of creating a form of binary option that offers the buyer of the option a fixed payout triggered by the occurrence of a specified event which can be clearly identified as having occurred or not occurred by a specified expiration date. In one example, a financial product is described per which a user (e.g., trader) may effectively trade a call option spread on a futures contract. Two call options (or two put options) on futures may be bundled, traded, and processed in tandem accordingly. The two options may comprise a tandem option that may be constructed with strike/exercise prices that are scaled to be one minimum price increment or tick apart in the underlying futures market. As a result of this scaling feature, the tandem options product, in this example, provides a payout at expiration that is binary in nature—it will either be zero or a fixed monetary amount. In other words, the minimum price increment of the underlying futures contract is established at the desired level to prevent the possibility that futures settle to some (analog) number in between the strike prices, resulting in an analog, as opposed to a binary, payout. A monetary valued multiplier would be applied to the minimum price increment to arrive at the desired monetary payout for the tandem option.

At least one advantage of creating a system and method for processing an option that delivers a fixed payout in this manner includes operational and regulatory considerations. For example, under the current Commodity Exchange Act, the concept of an option on a futures contract is an established and accepted regulatory design. Seemingly, various aspects of a tandem option, such as in some examples being construed as options on cash-settled futures contracts, would fall under this established regulatory framework and provide value as such. Moreover, various aspects of a tandem option dovetail with existing operational capabilities of derivatives exchanges as the effective payments may be accomplished through offset of the resulting derivatives positions within the context of well-established processes and system for implementing these processes.

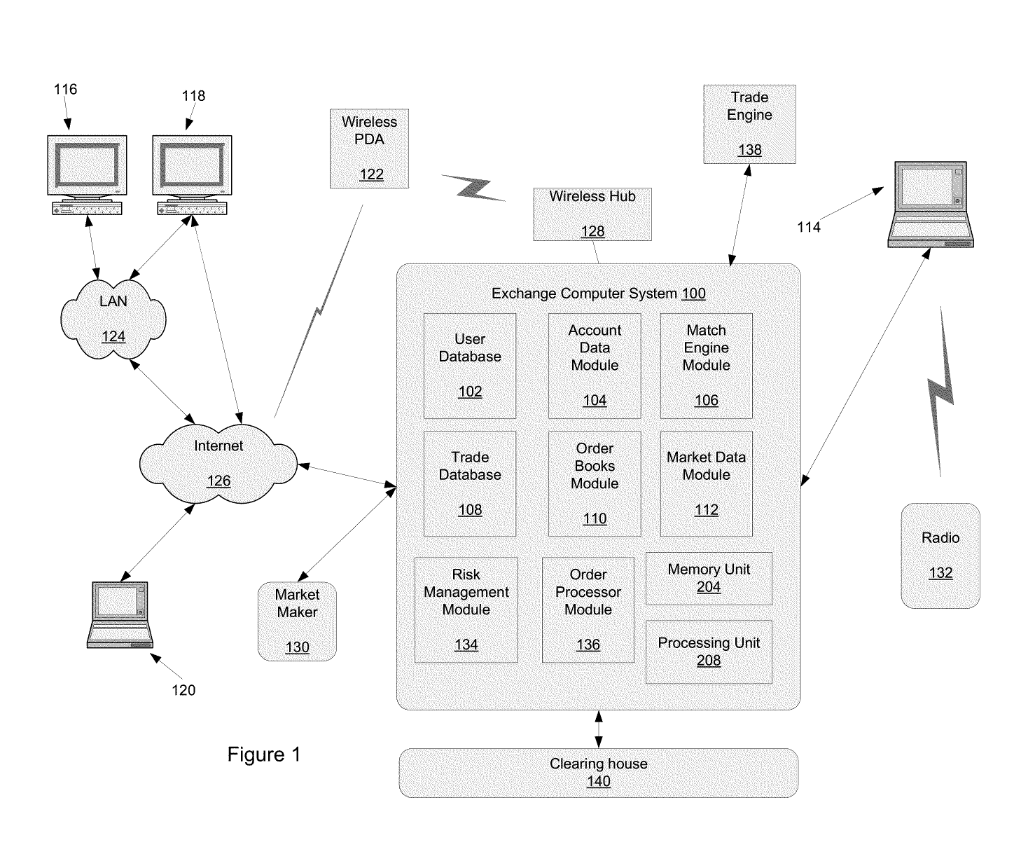

FIG. 1 depicts an illustrative operating environment that may be used to implement various aspects of the disclosure. The operating environment is only one example of a suitable operating environment and is not intended to suggest any limitation as to the scope of use or functionality of the features disclosed herein. Aspects disclosed herein are preferably implemented with computing devices and networks for exchanging, transmitting communicating, administering, managing and facilitating trading information including, but not limited to performance bond amount requirements and trading information. An exchange computer system 100 receives market data, analyzes historical data, calculates, and disseminates various values, e.g., accrued amounts associated with the declining balance methodology, historical accrual amounts, daily settlement price adjustments, cash payment etc., in accordance with aspects of the disclosure.

Exchange computer system 100 may be implemented with one or more mainframes, servers, gateways, controllers, desktops or other computers. The exchange computer system 100 may include one or more modules, processors, databases, mainframes, desktops, notebooks, tablet PCs, handhelds, personal digital assistants, smartphones, gateways, and/or other components, such as those illustrated in FIG. 1. Moreover, computer system 100 may include one or more processors 208 (e.g., Intel® microprocessor, AMD® microprocessor, risk processor, etc.) and one or more memories 204 (e.g., solid state, DRAM, SRAM, ROM, Flash, non-volatile memory, hard drive, registers, buffers, etc.) In addition, an electronic trading system 138, such as the Globex® trading system, may be associated with an exchange 100. In such an example, the electronic trading system includes a combination of globally distributed computers, controllers, servers, networks, gateways, routers, databases, memory, and other electronic data processing and routing devices. The trading system may include a trading system interface having devices configured to route incoming messages to an appropriate devices associated with the trading system. The trading system interface may include computers, controllers, networks, gateways, routers and other electronic data processing and routing devices. Incoming messages may be received directly or indirectly (e.g., over the Internet, over a wired or wireless network, etc.) from a computing device 120 of a user and sent to a trading platform system 100. Orders that are placed with or submitted to the trading system are received at the trading system interface. The trading system interface routes the order to an appropriate device. A trading engine computer system 100 receives orders and transmits market data related to orders and trades to users.

A user data store (e.g., user database 102) may include information identifying traders and other users of exchange computer system 100. Such information may include user names and passwords. A trader operating an electronic device (e.g., computer devices 114, 116, 118, 120 and 122) interacting with the exchange 100 may be authenticated against user names and passwords stored in the user database 112. Furthermore, an account data module 104 may process account information that may be used during trades. The account information may be specific to the particular trader (or user) of an electronic device interacting with the exchange 100.

A match engine module 106 may match bid and offer prices for orders configured in accordance with aspects of the disclosure. Match engine module 106 may be implemented with software that executes one or more algorithms for matching bids and offers for financial instruments in accordance with aspects of the disclosure. The match engine module 106 and trading system interface may be separate and distinct modules or component or may be unitary parts. Match engine module may be configured to match orders submitted to the trading system. The match engine module may match orders according to currently known or later developed trade matching practices and processes. In an example, bids and orders are matched on price, on a FIFO basis. The matching algorithm also may match orders on a pro-rata basis or combination of FIFO and pro rata basis. Other processes and/or matching processes may also be employed.

Moreover, a trade database 108 may be included to store historical information identifying trades and descriptions of trades. In particular, a trade database may store information identifying or associated with the time that an order was executed and the contract price. The trade database 108 may also comprise a storage device configured to store at least part of the orders submitted by electronic devices operated by traders (and/or other users). A confirmation message may be sent when the match engine module 106 finds a match for an order and the order is subsequently executed. The confirmation message may, in some examples, include an e-mail message to a trader, an electronic notification in one of various formats, or any other form of generating a notification of an order execution. In addition, a risk management module 134 may be included in computer system 100 to compute and determine the amount of risk associated with a financial product or portfolio of financial products. Furthermore, an order book module 110 may be included to compute or otherwise determine current bid and offer prices. The order book module 110 may be configured to calculate the price of a financial instrument.

In addition, an order processor module 136 may be included to receive data associated with an order for a tandem option. In one example, the order processor module 136 may decompose delta based order types, bulk order types, and/or tandem option orders for processing by order book module 110 and match engine module 106. The order processor module 136 may be configured to process the data associated with the orders (e.g., order for a tandem option with particular parameters) or additional attributes to handle post-trade routing. In some examples, the order processor module 136 may process the financial instrument to add and/or remove attribute in the financial instrument before sending to a clearing house. At least one reason, among others, for adding and/or removing attributes in the financial instrument before sending to the clearing house may be for backwards compatibility reasons; the clearing house may not necessarily be aware of this attribute in order to perform its functions.

In addition, a market data module 112 may be included to collect market data and prepare the data for transmission to users. In one example, the market data module 112 may publish the value of the current accrual amount, and/or the daily settlement price adjustment amount, and/or the cash payment amount. The market data module 112 may regularly disseminate updates to a financial instrument, including updates to the financial instrument that may occur as values (e.g., dividend announcements) are reported. The market data may be reported anonymously, clearing firm specific, and/or broker/trader specific in some examples. In some examples in accordance with aspects of the disclosure, the market data module 112 may update the market data records of a financial instrument on a daily basis (e.g., at the end of each trading day).

The trading network environment shown in FIG. 1 includes computer (i.e., electronic) devices 114, 116, 118, 120 and 122. The computer devices 114, 116, 118, 120 and 122 may include one or more processors, or controllers, that control the overall operation of the computer. The computer devices 114, 116, 118, 120 and 122 may include one or more system buses that connect the processor to one or more components, such as a network card or modem. The computer devices 114, 116, 118, 120 and 122 may also include interface units and drives for reading and writing data or files. Depending on the type of computer device, a user can interact with the computer with a keyboard, pointing device, microphone, pen device or other input device. For example the electronic device may be a personal computer, laptop or handheld computer, tablet pc and like computing devices having a user interface. The electronic device may be a dedicated function device such as personal communications device, a portable or desktop telephone, a personal digital assistant (“PDA”), remote control device, personal digital media system and similar electronic devices.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a local area network (LAN) 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

The operations of computer devices and systems shown in FIG. 1 may be controlled by computer-executable instructions stored on computer-readable storage medium. Examples also may take the form of electronic hardware, computer software, firmware, including object and/or source code, and/or combinations thereof. Examples may be stored on computer-readable media installed on, deployed by, resident on, invoked by and/or used by one or more data processors (e.g., risk processor), controllers, computers, clients, servers, gateways, networks of computers, and/or any combinations thereof. The computers, servers, gateways, may have one or more controllers configured to execute instructions embodied as computer software. For example, computer device 120 may include computer-executable instructions for receiving updated settlement prices, accrued amounts, and other information from computer system 100 and displaying to a user. In another example, computer device 118 may include computer-executable instructions for receiving market data from computer system 100 and displaying that information to a user. In yet another example, a processor of computer system 100 may be configured to execute computer-executable instructions that cause the system 100 to perform methods disclosed herein.

One or more market makers 130 may maintain a market by providing bid and offer prices for a derivative or security to exchange computer system 100. Exchange computer system 100 may also exchange information with other trade engines, such as trade engine 138 (or alternatively, the exchange computer system 100 may include trade engine 138). One skilled in the art will appreciate that numerous additional computers and systems may be coupled to exchange computer system 100. Such computers and systems may include clearing, regulatory and fee systems, such as clearing house 140. Coupling can be direct as described or any other method described herein.

A clearing house 140 enables an exchange computer system 100 to provide contracts with mutualized risk of counterparty credit risk than over-the-counter (OTC) products. A clearing house 140 arranges for transactions to be settled and cleared. Clearing is the procedure through which a clearing house 140 becomes buyer to each seller of a contract (e.g., futures contract, equities, currencies, interest rate products, etc.), and seller to each buyer, and assumes responsibility for protecting buyer and seller from financial loss by assuring performance on each contract. A clearing house 140 may settle trading accounts, clear trades, collect and maintain performance bond funds, regulate delivery and report trading data. In some scenarios an exchange may operate its own clearing house 140 through a division of the exchange through which all trades made are confirmed, matched, and settled each day until offset or delivered. In other words, the exchange computer system 100 may be internal to the clearing house 140. Alternatively, one or more other companies may be provided the responsibility of acting as a clearing house 140 with the exchange (and possibly other exchanges). An exchange may have one or more clearing houses associated with the exchange. An exchange may offer firms qualified to clear trades to provide a clearing house 140 for the exchange computer system 100. In some instances, these clearing members may be designated into different categories based on the type of commodities they can clear and other factors.

The clearing house 140 may establish minimum performance bond (i.e., margin) requirements for the products it handles. A customer may be required to deposit a performance bond with the clearing house 140 (or designated account) for the purpose of insuring the clearing house 140 against loss on open positions. The performance bond helps ensure the financial integrity of brokers, clearing houses, and exchanges as a whole. If a trader experiences a drop in funds below a minimum requirement, the clearing house 140 may issue a margin call requiring a deposit into the margin account to restore the trader's equity. A clearing house 140 may charge additional performance bond requirements at the clearing house's discretion. For example, if a clearing house's potential market exposure grows large relative to the financial resources available to support those exposures, the clearing house 140 may issue a margin call.

In another example, the clearing house 140 may require a larger performance bond based on a credit check (e.g., an analysis of the credit worthiness, such as using a FICO™ or comparable score, inter alia) of the customer/trader. The credit check may be performed (i.e., initiated) by a clearing house 140 or an exchange 100. In the example where the clearing house 140 performs the credit check, the clearing house 140 may send a message (e.g., enforcement message) to the exchange 100. If the credit check indicates that a customer/trader is a high risk, the enforcement message may increase the margin requirements of the customer/trader, or otherwise adjust the capabilities/constraints of the customer/trader commensurate with the higher risk. In the example where the exchange 100 initiates the credit check, the exchange 100 may send a message to one or more clearing houses associated with the exchange 100 to update them on the increased/decreased risk associated with the customer/trader.

The principal means by which a clearing house 140 mitigates the likelihood of default is through mark-to-market (MTM) adjustments. The clearing house 140 derives its financial stability in large part by removing debt obligations among market participants as they occur. Through daily MTM adjustments, every contract is debited or credited based on that trading session's gains or losses. For example, as prices move for or against a position, funds flow into or out of the trading account. This cash flow is known as settlement variation.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

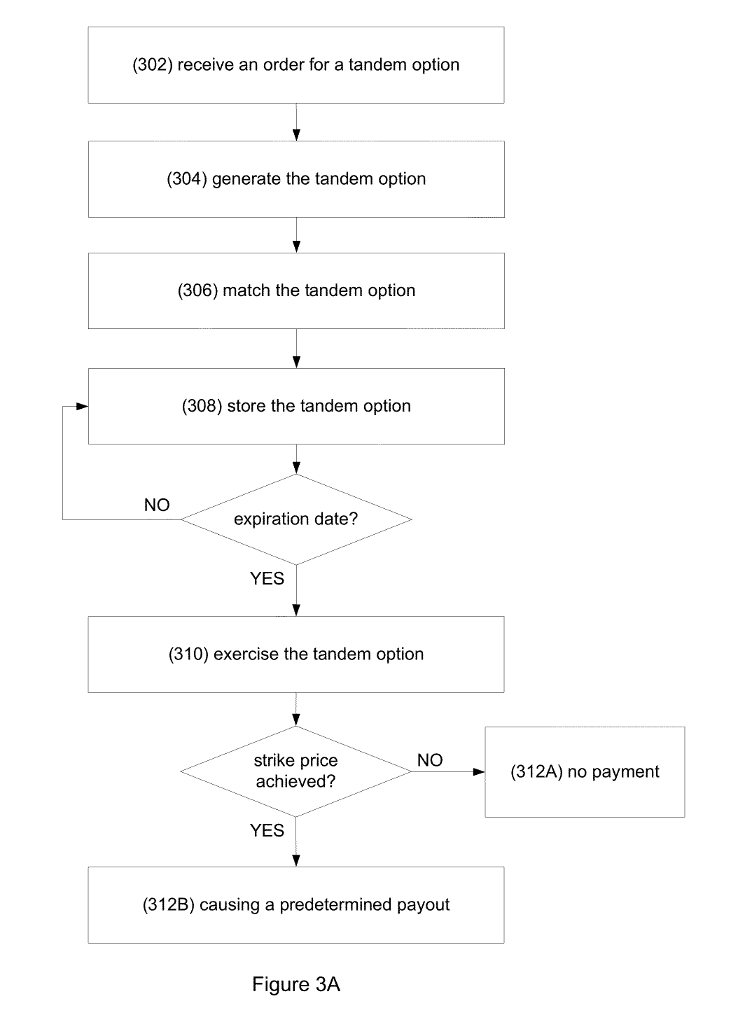

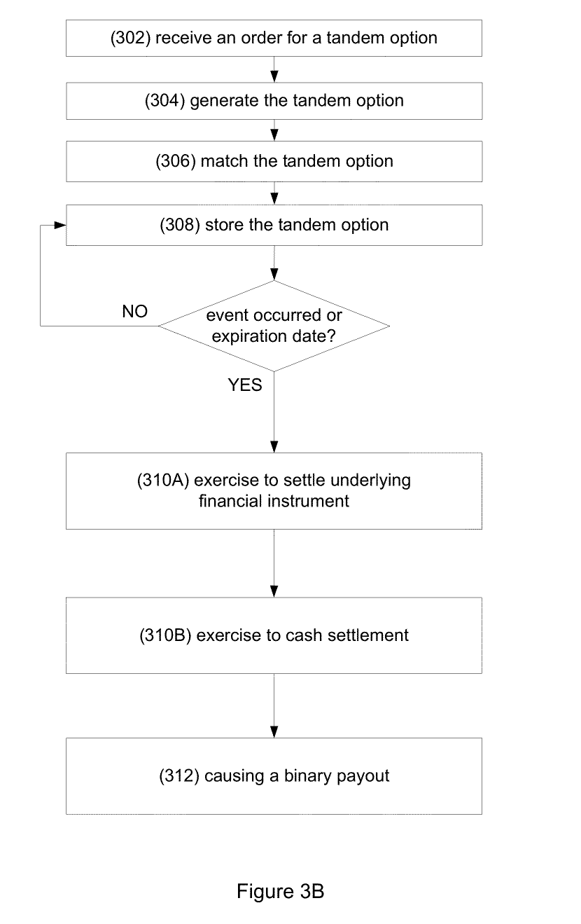

Referring to FIG. 3A and FIG. 3B, in one example in accordance with various aspects of the disclosure, a method is disclosed for receiving 302, from a computing device 120 of a user, an order for a tandem option. The order for a tandem option may comprise one or more of: a specified underlying financial instrument, a specified expiration date, a strike price (e.g., a strike price corresponding to the greater strike price between the two options contracts of the tandem option), and/or a position (e.g., a long position or short position based on whether the greater strike price corresponds to the long position or the short position of the tandem option). Upon receipt of the parameters of the order at the system 100, the system 100 may generate 304 a tandem option 200 using those parameters. For example the tandem option may comprise a first options contract and a second options contract. The first options contract may be for a specified underlying financial instrument with a first strike price and a specified expiration date. In addition, the first options contract may be for a long position. Meanwhile, the second options contract may be for a short position. The second options contract may be for the same specified underlying financial instrument and for the same specified expiration date, however, the strike price of the second options contract will be different.

The generated tandem option at system 100 may be matched 306 and processed using a matching engine module 106 and/or order processor module 136. In one example, the order may be received at system 100 and sent to match engine module 106 for processing, then to risk management module 134 to approve the risk (e.g., that sufficient margin is available to protect against risk), then to order processor module 136, then back to match engine module 106. In some examples, the order of interaction between the risk management module 134 and order processor module 136 may be interchanged, or the order may be initially sent to the order processor module 136 for pre-processing before being sent to the match engine module 106.

In addition, the strike price of the first options contract and the strike price of the second options contract may be a function of the preset minimum price increment of the specified underlying financial instrument. For example, assume the strike price of the first options contract is $100. Meanwhile, the preset minimum price increment of that specified underlying financial instrument is $10. Therefore, the strike price of the second options contract would be $90. Alternatively, assuming the strike price of the first options contract is $100 and the preset minimum price increment of that specified underlying financial instrument is $10, the strike price of the second options contract may be $110. In other words, the strike price of one options contract of the tandem option may be a function (e.g., plus, minus, etc.) of the specified strike price and a preset minimum price increment.

At least one reason for establishing a preset minimum price increment of the underlying financial instrument is because at the payout of the tandem option, the user receives one of two possible payouts (i.e., a binary payout). By establishing a relationship between the two strike prices as a function of the minimum price increment, the system guarantees that the payouts will be either zero or the value of the minimum price increment multiplied by a preset multiplier. For example, in a tandem option for a “short 100,” one options contract will have a $100 strike price. Meanwhile, the other options contract's position will have a strike price at $90. Such a tandem option may be referred to as a bearish tandem option because the short position is greater than the long position. As such, an order for a particular tandem option may, in some examples, include an input of a single strike price, and the second strike price may be calculated based on the minimum price increment established for the specified underlying financial instrument of the tandem option.

In addition, the tandem option may include a specified expiration date that coincides with the final settlement date of the specified underlying financial instrument. Such an arrangement includes aspects of an European-style option. European-style options include a final settlement date, and do not permit exercising of the option prior to the final settlement date. In contrast, American-style options permit an exercise of the option any time prior to or at the final settlement date. See FIG. 3B. In numerous examples in accordance with various aspects of the disclosure, the specified expiration date of the tandem option corresponds to the final settlement date of the underlying financial instrument.

Once the tandem option has been generated, the match engine module 106 may attempt to match 306 the tandem option using any of various methods. For example, the match engine module 106 may attempt to find another tandem option to match with the incoming option. Alternatively, the match engine module 106 may decompose the tandem option into a first and second option. Then, the match engine module 106 may attempt to find a match for each of the first and second options independently. Once a match has been found for both the first option and the second option, then the match engine module 106 may indicate to one or more other modules that the tandem option has been matched. Of course, aspects of such matching may introduce legging/slippage risk into the process. However, the system 100 may use one or more methods known to those of skill in the art, such as locking the appropriate market for a limited amount of time, or using one or more types of semaphores.

Once the match engine module 106 has matched the tandem option, the tandem option may be actually traded (i.e., an exchange-traded tandem option). After being traded, the tandem option may be stored 308 in computer memory. In some examples, such computer memory may be located at an exchange computer system 100. In other examples, such computer memory may be located at a clearinghouse 140. The tandem option may be stored while it awaits its expiration date. In the interim, it may be priced using one or more options/futures pricing methodologies.

Upon occurrence of the specified expiration date in the example of a European-style option, the system may calculate a binary payout (see 312). The binary payout may consist of one of two possible values: zero (see 312A), or the preset minimum price increment scaled by a preset multiplier (see 312B). For example, if that minimum price increment is $10 and the preset multiplier is one, then, the binary payout at expiration of the tandem option would be $10.

In some examples, under the current regulatory regime, it may be advantageous at the expiration date of the tandem option to first settle the tandem option into its underlying futures contract (see 310A), and then to undergo cash settlement (see 310B). In other examples, any underlying financial instrument might not need to be settled, rather the tandem option may be directly cash settled. Of course, a person having ordinary skill in the art will appreciate that as the regulatory framework is modified, the disclosure contemplates varying methodology (e.g., order and steps performed) of settlement.

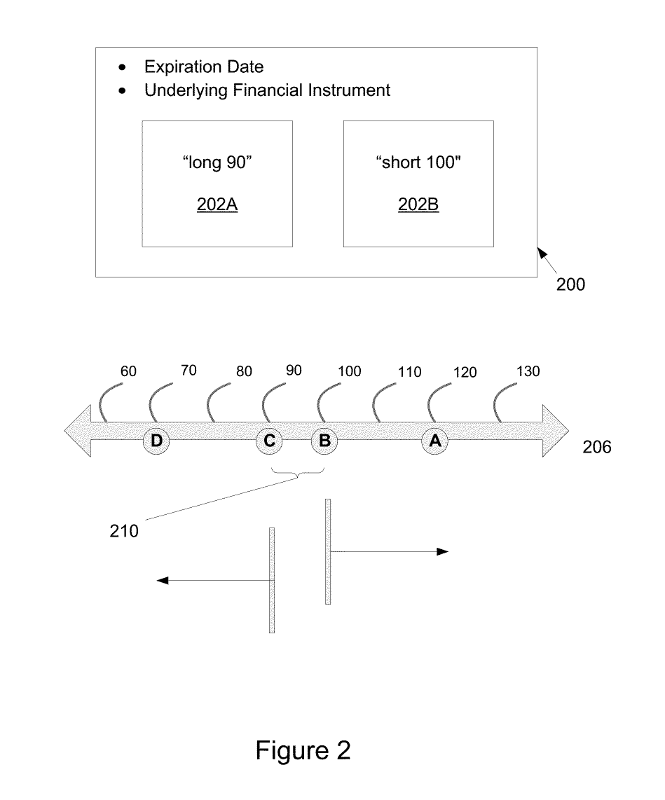

Referring to FIG. 2, in one example involving a bullish tandem option at a 100 strike price, the exchange computer system 100 may receive an order for a bullish tandem order identifying numerous parameters. The tandem option 200 may include a a long call position and a short call position. The long call position may be a first options contract 202A (with a strike price equal to 90) and a second short call options contract 202B (with a strike price equal to 100). In this case since the tandem option is a bullish option position, the strike price of 90 is associated with the long call position, and the strike price of 100 is associated with the short call position Referring to reference 206 which is a graph showing the different prices available for the specified underlying financial instrument, the graph 206 indicates that the preset minimum price increment 210 is 10 (or 10 units). In other words, the underlying instrument is priced such that there is no price for the underlying instrument between 90 and 100. As such, four scenarios may be possible. In a first scenario, if at the specified expiration date the tandem option 200 hold a price of 120, then the price would fall at “point A” in graph 206. As depicted in FIG. 2, this means that the first options contract 202A would be in-the-money. Meanwhile, the second options contract 202B would be in-the-money. As such, the payout of the tandem option 200 would be the preset minimum price increment 210, which is 10, multiplied by a preset multiplier (e.g., $1, $10, $100, $1,000, or any other monetary value, including values other than multiples of 10 and decimal values).

In another scenario, if the price of the specified underlying financial instrument at the expiration date is at “point B” on graph 206, then the long option 202A would be in-the-money, but the short position option 202B would be at-the-money. As such the fixed payout would again be 10, which is the preset minimum price increment 210, multiplied by the preset multiplier. Although both preceding scenarios describe the payout as being a multiplication of the preset minimum price increment by the preset multiplier, this disclosure is not so limited. The disclosure contemplates the fixed payout being a function of the two inputs of preset minimum price increment and preset multiplier.

In contrast, if the final strike price at the specified expiration date of the tandem option 200 is at “point C” on graph 206, then the long position option 202A would be at-the-money. In addition, the short position option 202B would be out-of-the-money. Therefore, the fixed payout for the tandem option 200 would be zero. Likewise, if the final strike price falls at “point D” on the graph 206, the ultimate results would be the same: a zero payout. The reason for a zero payout at the final strike price at “point D” in graph 206 is because at that final strike price option 202A is out-of-the-money, and option 202B is out-of-the-money. Therefore, the overall tandem option 200 would be entitled to a net fixed payout of zero dollars.

In another example in accordance with various aspects of the disclosure, assume that a user desires to create a tandem option product that generates a payout of $1,000, that is triggered if the price of a particular underlying financial product (e.g., a futures contract, event contract, or other product) were to be in excess of 150 points at a specific expiration date. The user submits an order to the system 100 to buy a tandem option that consists of buying one 149 struck call and sell one 150 struck call. The order submission may include the appropriate parameters to be sent to the exchange computer system 100. Furthermore, the minimum price increment or tick value of the futures contract may be established at 1 point, with a multiplier equal to $1,000 (thus, the fixed binary equals $1,000×1 point, else zero). Alternatively, the minimum price increment or tick of the options may be established at some fraction of 1 point, e.g., at a minimum price increment of 0.01, then the binary payout will be either $10 (=$1,000×0.01 points) or a zero payout.

With these determinations finalized, the exchange computer system 100 may create an options contract (e.g., call option, put option, etc.) that is exercisable for one futures contract with a strike/exercise price of 149; and, create another option (e.g., the same type as the aforementioned options contract) that is exercisable for one futures contract with a strike or exercise price of 150. The exchange computer system 100 may identify the corresponding futures contract, which may be cash settled at a value of $1,000 times the value of the product. The tandem option may be traded and quoted on a net basis. As a matter of option mathematics, the net premiums of the two option contracts making up the tandem option are bounded by 0.00 and 1.00 points.

Assuming these options are constructed as European style options that may only be exercised 310 on the specified expiration date, then the tandem option's expiration date would also coincide with the final settlement date of the associated futures contract. As a result, the tandem option may ultimately expire/be exercised in one of several possible scenarios.

In one scenario, assuming that the market is below the lower of the two strike prices (i.e., less than 149) at option expiration, then both the 149 long call and the 150 short call are out-of-the-money and worthless at expiration. Thus, the binary payout at option expiration is zero. In another similar scenario, assuming that the market is at the lower of the two strike prices (i.e., equal to 149) by option expiration, then the 149 long call is at-the-money while the 150 short call is out-of-the-money; and both options are worthless at expiration. Thus, the binary payout at option expiration is again $0.

In another scenario, assuming that the market is at the upper of the two strike prices (i.e., equal to 150) at option expiration, then the 149 long call is in-the-money by one point (or $1,000 assuming the tandem option for the specified underlying financial instrument was preset at $1,000 equals one point) at expiration; meanwhile, the 150 short call is at-the-money and worthless at expiration. Thus, the binary payout at option expiration is $1,000 instead of the other binary value of zero. Likewise, in another scenario, assuming that the market is above the upper of the two strike prices (i.e., greater than 150) at option expiration, then both the 149 long call and 150 short call are in-the-money. The 149 long call is exercised for its in-the-money or intrinsic value (i.e., current price minus 149) while the 150 short call is exercised at a loss equal to its in-the-money or intrinsic value (i.e., 150 minus the current price). The net of both payouts reduces to the difference between the two strike prices (i.e., 150 minus 149), and the tandem option generates a net binary payout of 1 point (multiplied by the preset multiplier) or $1,000 again.

Although the tandem option in the preceding example was configured to generate a payout of $1,000 if the price of the particular underlying financial product were to be in excess of 150 points at a specified expiration date, in an alternate example, aspects of the tandem option may be configured to resemble a “knock-in” option. Similar to a knock-in option, in one example a tandem option may be configured with a first option contract having a long call position (with a strike price equal to 149.9) and a second options contract with a short call position (with a strike price equal to 150.0). The preset minimum price increment in this case is 0.1, and as such, the fixed binary payout is 0.1 multiplied by a preset multiplier (e.g., $1, $500, $10,00, etc.). The tandem option is configured to have its condition met if at any time at or before the specified expiration date, the price of the underlying financial product is at or in excess of 150, regardless of its actual value on the specified expiration date. Continuing with the preceding example involving a “knock-in” feature, in some examples, aspects of the of the tandem option may be further configured to allow exercise (see 310A, 310B) of the tandem option anytime at or before the expiration date (e.g., similar to an American-style option). In other examples, similar to those described herein, the tandem option may be configured to follow an European-style option configuration.

Moreover, with several of the examples provided herein, the profits (or losses) resulting from a tandem option may be reduced by the initial net premium that it costs to establish the long tandem option position in the first place. The user (e.g., trader) who sells or shorts the tandem option by taking the opposite position of the long, may generate losses (profits) precisely opposite to that of the long.

In accordance with various aspects of the disclosure, several of the examples disclosed herein have made reference to a strike price at the expiration date of the tandem option, the disclosure also contemplates event contracts that may be triggered by the occurrence (or failure of occurrence) of a specified event. Tandem options may represent, in one example, a particular product construction designed to offer a user (e.g., trader) the opportunity to earn a fixed payment (e.g., $100, $1,000, $10,000, etc.) upon occurrence of a specified event, on or before a specified expiration date. (See FIG. 3B). As such these tandem options represent a form of “event contract” or more specifically a “binary event contract” with a payout (see 312) of either $X or zero.

Event contracts are sometimes referred to using a variety of different names including binary options, event futures, event markets, prediction markets, decision markets, proposition markets, opinion markets, idea marks, claim markets, information aggregation markets, unconventional markets, non-traditional markets, digital options, and others.

Often times a tandem options contract involving event contracts is established as described herein, however, the disclosure contemplates many variations on these basic concepts/principles. A tandem option consisting of two (binary) event contracts may be cash settled at a value of either 100 points or 0 points upon maturation. The contract multiplier may be established at any level, e.g., $1, $10, $100, implying a payout of $100, $1,000, $10,000, respectively. In another example, a digital event contract may be established that pays $X for every Y points by which a figure deviates from an arbitrary standard, e.g., the tandem options contract might pay $1,000 for every 50,000 jobs reported in the monthly Non-Farm Payroll release. Meanwhile, tandem options contracts may also be established that pay even money if the outcome exceeds X level or $0 otherwise. The reference level X or the spread may vary depending upon trade interest. A pari-mutuel format may also be deployed to react to trade interest and establish the spread.

In accordance with various aspects of the disclosure, prediction futures are also contemplated for use in various aspects of tandem options and binary payouts. Quotations of event futures may be interpreted sometimes as generally indicative of the probability that the event will occur. Thus, they are sometimes referred to as “prediction futures.” For example, a bid of 32 implies that the user believes that the event is likely to occur with a probability of 32% or better. An offer of 35 implies that the user believes that the event is likely to occur with a probability of 35% or less. Tandem options and markets for tandem options are similar in some aspects to digital or binary options, however, tandem options comprise, inter alia, enhanced pricing configurations and other features. In one example, an event contract may be quoted on a scale from zero to one hundred. Assuming that the minimum tick size (e.g., preset minimum price increment) equals one index point, a bid/ask spread might be quoted at, for example, 32/35. The value of a tick may be implied by a contract multiplier (e.g., a preset multiplier or scaler) as discussed above. Thus, a multiplier of $1 might imply a $1 tick, a $10 multiplier might imply a $10 tick, and so on.

In addition, in some examples involving weather options, tandem option trades may be converted to “standard deviations” using a model based on Stephen Jewson's model for pricing weather. This standard deviation creates prices in the entire options series which may then be applied to open strikes.

In accordance with various aspects of the disclosure, the order for a tandem option may be in a recognized format (e.g., the FIX/FAST format) and include information in its message format that facilitates matching by an electronic match engine module 106 of the tandem option with the one or more pending orders. That information may include multiple order book identifiers or other information useful to the match engine module 106 to match the order for the tandem option. In one example, the tandem option may be marked as “Fill and Kill”or “Fill or Kill;” thus, further reducing the user's risk by ensuring that the order for the tandem option does not rest on the order book if a match does not exist.

An exchange computer system 100 may match an order for the tandem option with another order for a mirrored tandem option (i.e., an incoming order for a 100 long/90 short windspeed tandem order may be matched with an existing, outstanding order for a 100 short/90 long windspeed tandem order). In some instances, the volume of trading of a particular tandem option might be low and does not provide immediate liquidity for an incoming order. Alternatively, some exchange computer systems 100 may attempt to match the legs/components of order for tandem options with multiple existing order or from the legs of appropriate spread product orders. As such, spread products and/or tandem options may be broken down (e.g., decomposed) into a collection of legs/options and an attempt may be made to separately match orders for each of the legs.

In one example, the match engine module 106 may, in some examples, verify the information that facilitates matching by confirming the status of pending orders that will be matched against the two components (e.g., legs) of the tandem option. The exchange computer system 100 may perform the verifying in the match engine module 106 itself, or alternatively, delegate this activity to another module where the verifying may occur in a separate thread running in parallel with the match engine module 106. If the verification finds an implied spread to be valid, then a notification of the implied spread may be sent to the match engine module 106 for executing both of the components (e.g., legs) of the tandem option against the identified pending/existing orders. At least one advantage of executing all of the legs of the tandem option in a nearly simultaneous manner is that there is miniscule slippage risk (e.g., all of the trades are executed before a material change in the appropriate markets). The abundance of processing power at the electronic match engine module 106 is at least one factor that may permit the matching of the legs of the tandem option with minimal or no legging risk. For example, the electronic match engine module 106 may execute the implied transaction inline without requiring a locking of the markets involved. In alternate examples, an exchange computer system 100 may lock one or more markets for the orders involved to eliminate possible legging risk.

In accordance with the disclosure herein, a system is contemplated for generating and/or displaying a graphical user interface (GUI) with user-input fields for entry of one or more parameters for an order for a tandem option product. The system may comprise a processor, memory, and/or a display to execute computer-executable instructions recorded on the memory. The instructions may allow a user to select/enter values for one or more of the aforementioned parameters, including, for example, a financial instrument, desired strike price, and other information. The instructions may take the inputted information and generate a tandem option, as described herein, for processing by an exchange computer system 100. The exchange computer system 100 may collect and organize the received information into a GUI for display to a user of user computing system 120.

Although numerous of the examples herein have made reference to call options, the tandem option disclosed herein may alternatively be created using a combination (e.g., tandem) of put options. In any event, the tandem option is struck over a span equal to the binary payout that one wishes to replicate, and the minimum price increment or tick size associated with the futures contract is established to equal that strike price span, e.g., 1 point or $1,000 as in some of the examples above.

Financial instruments may include, but are not limited to, swap agreements, credit defaults swaps (CDS), interest rate swaps (IRS), forward rate agreements (FRAs), OTC equities, OTC foreign currency, derivative contracts, equities, currency swaps (FX), bilateral financial agreements, financial agreements involving a central clearing party/central counterparty (CCP), event contracts, prediction futures, futures contracts, and other comparable financial instruments apparent to one skilled in the art after review of the entirety disclosed herein. A financial instrument may include a standardized over-the-counter (OTC) agreement. The agreement may be standardized/harmonized through a set of specifications promulgated by an association (e.g., International Swaps & Derivatives Association) or entity (e.g., a clearing house, etc.) For example, the agreement may include one or more of commonplace attributes/terms such as, but not limited to: price, notional amount, maturity/term, triggering event (e.g., in the case of a CDS), identification of a party/parties (e.g., a protection buyer) to the agreement.

The present disclosure has been described herein with reference to specific illustrative embodiments thereof. It will be apparent to one skilled in the art that a person understanding this disclosure may conceive of changes or other embodiments or variations, which utilize the principles disclosed herein without departing from the broader spirit and scope of the disclosure as set forth in the appended claims. One or more of the steps illustrated in the figures and specification may be optional and may be omitted from various embodiments. For example, although this disclosure contemplates a double auction design (e.g., a traditional format where buyers submit bids and sellers submit offers for matching on a price basis is employed), other known configurations may also be used herein.

I/we claim:

1. A method comprising:
a. receiving, by a processor of an exchange computer system, an order for a tandem option, wherein the order comprises parameters comprising at least a specified strike price and a specified position of one of: a long position and a short position;
b. generating, by the processor, the tandem option comprising:
i. a first options contract with the long position on a specified underlying financial instrument with a first strike price and a specified expiration date, and
ii. second options contract with the short position on the specified underlying financial instrument with a second strike price and the specified expiration date;
wherein the specified expiration date is a fixed date that coincides with a final settlement date of the specified underlying financial instrument; and
wherein one of the first strike price and the second strike price is equal to the specified strike price, and the other strike price is the specified strike price minus a preset minimum price increment of the specified underlying financial instrument;
c. storing, by the processor, the tandem option in computer memory; and
d. upon occurrence of the specified expiration date, causing, by the processor, a binary payout consisting of one of: zero, and the preset minimum price increment scaled by a preset multiplier.

2. The method of claim 1, wherein the order for the tandem option includes parameters comprising the specified underlying financial instrument, the specified expiration date, the specified strike price, and the specified position.

3. The method of claim 1, further comprising:
e. if the specified position is the long position, then setting, by the processor, the first strike price to the specified strike price and the second strike price to the specified strike price minus the preset minimum price increment;
f. if the specified position is the short position, then setting, by the processor, the second strike price to the specified strike price and the first strike price to the specified strike price minus the preset minimum price increment; and
g. sending, by the processor, the tandem option to a match engine module of an exchange computer system configured to match the tandem option.

4. The method of claim 1, further comprising:
e. before causing the binary payout, settling the tandem option into the specified underlying financial instrument, then settling the specified underlying financial instrument for cash.

5. The method of claim 1, wherein the causing the processor to authorize a binary payout includes:
exercising in tandem, by the processor, the first options contract and the second options contract;
determining, by the processor, that a final price of the specified underlying financial instrument at the occurrence of the specified expiration date puts the tandem option in-the-money; and
crediting an accountholder of the tandem option with the preset minimum price increment scaled by the preset multiplier.

6. The method of claim 1, wherein the causing the processor to authorize a binary payout includes:
exercising in tandem, by the processor, the first options contract and the second options contract;
determining, by the processor, that a final price of the specified underlying financial instrument at the occurrence of the specified expiration date puts the tandem option out-of-the-money; and
crediting an accountholder of the tandem option with the binary payout of zero.

7. The method of claim 1, wherein the computer memory storing the tandem option is located at the exchange computer system.

8. The method of claim 1, wherein the computer memory storing the tandem option is located at a clearinghouse.

9. The method of claim 1, wherein the storing the tandem option comprises:
decomposing, by a order processor module of an exchange computer system, the tandem option into the first options contract and the second options contract;
storing the first options contract in the computer memory; and
storing the second options contract in the computer memory.

10. The method of claim 1, wherein the specified underlying financial instrument is a futures contract related to weather.

11. The method of claim 10, further comprising:
e. determining a price, by the processor, of the tandem option based on a Jewson model for pricing weather event contracts.

12. An exchange computer system comprising:
at least one processor; and
at least one memory storing computer-executable instructions, that when executed by the at least one processor, cause the system to:
a. receive, by an order processor module of the exchange computer system, an order for an exchange-traded tandem option, wherein the order comprises parameters comprising at least a specified underlying financial instrument, a specified expiration date, a specified strike price, and a specified position;
b. generate the exchange-traded tandem option comprising:
i. a first options contract with the long position on the specified underlying financial instrument with a first strike price and the specified expiration date, and
ii. second options contract with the short position on the specified underlying financial instrument with a second strike price and the specified expiration date;
wherein the specified expiration date coincides with a final settlement date of the specified underlying financial instrument; and
wherein one of the first strike price and the second strike price is equal to the specified strike price, and the other strike price is a function of the specified strike price and a preset minimum price increment of the specified underlying financial instrument;
c. send the exchange-traded tandem option to a match engine module of the exchange computer system configured to match the tandem option;
d. store, by the processor, the exchange-traded tandem option in computer memory; and
e. upon occurrence of the specified expiration date, cause, by the processor, a binary payout consisting of one of: zero, and the preset minimum price increment scaled by a preset multiplier.

13. The system of claim 12, wherein the other strike price is equal to the specified strike price minus the preset minimum price increment of the specified underlying financial instrument.

14. The system of claim 12, wherein the computer-executable instructions, that when executed by the at least one processor, further cause the system to:
a. before causing the binary payout, settle the exchange-traded tandem option into the specified underlying financial instrument, then settling the specified underlying financial instrument for cash.

15. The system of claim 12, wherein the computer memory storing the exchange-traded tandem option is located at the exchange computer system.

16. The system of claim 12, wherein the computer memory storing the exchange-traded tandem option is located at a clearinghouse.

17. The system of claim 12, wherein the storing the exchange-traded tandem option comprises:
decomposing the tandem option into the first options contract and the second options contract;
storing the first options contract in the computer memory; and
storing the second options contract in the computer memory.

18. A non-transitory computer memory storing computer-executable instructions that, when executed by a processor, cause an apparatus to:
a. receive an order for a tandem option, wherein the order comprises parameters comprising at least a specified underlying financial instrument, a specified expiration date, a specified strike price, and a specified position;
b. generate the tandem option comprising:
i. a first options contract with the long position on the specified underlying financial instrument with a first strike price and the specified expiration date, and
ii. second options contract with the short position on the specified underlying financial instrument with a second strike price and the specified expiration date;
wherein the specified expiration date coincides with a final settlement date of the specified underlying financial instrument; and
wherein the first strike price is set to the specified strike price, and the second strike price is set to the specified strike price minus a preset minimum price increment of the specified underlying financial instrument;
c. match the tandem option with an existing order;
d. store the tandem option in the computer memory; and
e. upon occurrence of the specified expiration date, cause a binary payout consisting of one of: zero, and the preset minimum price increment scaled by a preset multiplier.

19. The non-transitory computer memory of claim 18, wherein the computer-executable instructions further cause the apparatus to:
f. before causing the binary payout, settle the tandem option into the specified underlying financial instrument, then settling the specified underlying financial instrument for cash.

20. The non-transitory computer memory of claim 18, wherein the non-transitory computer memory is located at an exchange computer system.
